(19) United States
(12) Patent Application Publication
(10) Pub. No.: US 2026/0318010 A1
(43) Pub. Date: Oct. 15, 2026

(54) TISSUE PRODUCTS HAVING TEXTURE GENERATED BY A CREPING BLADE

(71) Applicant: KIMBERLY-CLARK WORLDWIDE, INC., Neenah, WI (US)

(72) Inventors: Giovanni MASSAROTTI, Neenah, WI (US); Thomas DYER, Neenah, WI (US); Erin RILEY, Neenah, WI (US)

(21) Appl. No.: 19/485,899

(22) PCT Filed: Jun. 27, 2024
(86) PCT No.: PCT/US2024/035828

§ 371 Date: Nov. 19, 2025

Related U.S. Application Data
(60) Provisional application No. 63/524,583, filed on Jun. 30, 2023.

(51) Int. Cl. D21H 27/40; D21H 25/10; D21H 25/12

(52) U.S. Cl. CPC D21H 27/40; D21H 25/10; D21H 25/12; D10B 2401/062

(57) ABSTRACT

A multi-ply tissue product includes two or more wet pressed and creped tissue plies. The multi-ply tissue product defines a first outer surface and a second outer surface opposite the first outer surface. At least the first outer surface defines a three-dimensional surface topography including a plurality of ridges separated by valleys. Each of the plurality of ridges defines a height of 50 μm to 355 μm. Each of the plurality of ridges is spaced apart from an adjacent ridge by a distance of 500 μm to 2,000 μm. The multi-ply tissue product has an average stiffness index of 7.4 to 9.4, and a TS7 value of less than 15.

### BACKGROUND

This disclosure relates to absorbent tissue products, such as paper towels, facial tissues, bath tissues and other similar products, that are designed to include several important properties. For example, the products should have good bulk, a soft feel, and be highly absorbent. In addition, the products should also have sufficient strength for the particular application and environment in which they are to be used.

Some absorbent tissue products are produced using a creping process to increase bulk and improve softness. For example, in the creping process, a creping adhesive may be sprayed onto a rotating drum, such as a Yankee dryer. A tissue web is then adhered to an outside surface of the drum, and a creping blade is used to remove the tissue web from the surface of the drum. Creping the web from the drum compacts the web and can break fiber-to-fiber bonds, which increases the bulk and softness of the product.

### SUMMARY

In some aspects, the techniques described herein relate to a multi-ply tissue product including: two or more wet pressed and creped tissue plies, the multi-ply tissue product defining a first outer surface and a second outer surface opposite the first outer surface, at least the first outer surface defining a three-dimensional surface topography including a plurality of ridges separated by valleys, wherein: each of the plurality of ridges defines a height of 50 μm to 355 μm, each of the plurality of ridges is spaced apart from an adjacent ridge by a distance of 500 μm to 2,000 μm, the multi-ply tissue product has a stiffness index of 7.4 to 9.4, and the multi-ply tissue product has a TS7 value of less than 15.

In some aspects, the techniques described herein relate to a multi-ply tissue product including: two or more wet pressed and creped tissue plies, the multi-ply tissue product defining a first outer surface and a second outer surface opposite the first outer surface, at least the first outer surface defining a plurality of ridges formed by a textured creping blade and separated by valleys, wherein: the plurality of ridges includes 50 ridges per inch to 12 ridges per inch, each of the plurality of ridges is spaced apart from an adjacent ridge by a distance of 500 μm to 2,000 μm, the multi-ply tissue product has a geometric mean tensile of 1,100 g/3″ to 1,600 g/3″, the multi-ply tissue product has a stiffness index of 7.4 to 9.4, the multi-ply tissue product has a TS750 value greater than 45, and the multi-ply tissue product has a TS7 value of less than 13.

In some aspects, the techniques described herein relate to a method including: applying a creping composition to a Yankee dryer drum; applying a first tissue ply to the Yankee dryer drum; creping the first tissue ply from the Yankee dryer drum with a textured creping blade; applying a second tissue ply to the Yankee dryer drum; creping the second tissue ply from the Yankee dryer drum with the textured creping blade; and marrying the first tissue ply and the second tissue ply to create a multi-ply tissue product having a stiffness index of 7.4 to 9.4, a TS750 value of 40 to 112, and a TS7 value of less than 15.

This summary is illustrative only and is not intended to be in any way limiting. Other aspects, features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

Various implementations are explained in even greater detail in the following drawings. The drawings are merely exemplary and certain features may be used singularly or in combination with other features. The drawings are not necessarily drawn to scale.

FIG. 1 is a schematic representation of a wet pressed creped tissue web forming system, according to some implementations.

FIG. 2 is a schematic representation of another wet pressed creped tissue web forming system, according to some implementations.

FIG. 3 is a schematic representation of another wet pressed creped tissue web forming system, according to some implementations.

FIG. 4 is a schematic representation of a device for forming a multi-layered stratified pulp furnish, according to some implementations.

FIG. 5 is a schematic representation of an embossing system, according to some implementations.

FIG. 6 is a schematic representation of a creping blade, according to some implementations.

FIG. 7 is a graph showing TS7 versus TS750 for tissue products created according to some implementations.

FIG. 8 is a graph showing GMT versus caliper in microns for tissue products created according to some implementations.

FIG. 9 is a graph showing Geometric Mean Tensile versus Geometric Mean Slope for tissue products produced by systems and methods described herein, according to some implementations.

FIG. 10 is a graph showing Stiffness Index versus TS7 values for tissue products produced by systems and methods described herein, according to some implementations.

FIG. 11 is a photo of a tissue product created using a low texture creping blade, according to some implementations.

FIG. 12 is a photo of a tissue product created using a medium texture creping blade, according to some implementations.

FIG. 13 is a photo of a tissue product created using a high texture creping blade, according to some implementations.

### DETAILED DESCRIPTION

Following below are more detailed descriptions of concepts related to, and implementations of, multi-ply tissue products and methods, apparatuses, and systems for making multi-ply tissue products. Before turning to the figures, which illustrate certain exemplary implementations in detail, it should be understood that the present disclosure is not limited to the details or methodology set forth in the description or illustrated in the figures. It should also be understood that the terminology used herein is for the purpose of description only and should not be regarded as limiting.

Referring to the figures generally, the various implementations disclosed herein relate to multi-ply tissue products and systems, apparatuses, and methods for making multi-ply tissue products. The multi-ply tissue products include texture created using a creping blade that includes a textured blade edge. The textured creping blade imparts a visual texture to webs during formation, and the visual texture survives the finishing processes (e.g., marrying, embossing, etc.) to provide an improved caliper and desirable TS7 and TS750 values. For example, the texture created includes ridges generally extending in the machine direction of the tissue products that are separated by valleys. In some implementations the multi-ply tissue product is a bath tissue made using a creping chemistry compatible with bath tissues (e.g., conventional creping composition).

### Definitions

As used herein the term “Basesheet” refers to a tissue web formed by any one of the papermaking processes described herein that has not been subjected to further processing, such as embossing, calendering, treatment with a binder or softening composition, perforating, plying, folding, or rolling into individual rolled products.

As used herein the term “Tissue Product” refers to products made from basesheets and includes, bath tissues, facial tissues, paper towels, industrial wipers, foodservice wipers, napkins, medical pads, and other similar products.

As used herein, the term “Wet Pressed” generally refers to a tissue manufacturing process and tissue products made thereby where the partially dewatered tissue web is transferred to a felt and thereafter pressed onto the surface of a dryer while supported by the felt. Examples of wet pressed and modified wet pressed processes are disclosed, for example, in U.S. Pat. Nos. 3,953,638, 5,324,575 and 6,080,279.

As used herein the term “Ply” refers to a discrete tissue web used to form a tissue product. Individual plies may be arranged in juxtaposition to each other.

As used herein, the term “Layer” refers to a plurality of strata of fibers, chemical treatments, or the like, within a ply. The term “Layered Tissue Web” generally refers to a tissue web formed from two or more layers of aqueous papermaking furnish. In certain instances, the aqueous papermaking furnish forming two or more of the layers comprise different fiber types.

As used herein the term “Basis Weight” generally refers to the conditioned weight per unit area of a tissue and is generally expressed as grams per square meter (gsm). Basis weight is measured as described in the Test Methods section below. In certain instances, the multi-ply tissue products of the present disclosure may comprise two or more creped tissue plies, such as 2, 3 or 4 plies and have a basis weight ranging from 30 gsm to 80 gsm, such as from 40 gsm to 60 gsm, such as from 45 to 55 gsm, including exemplary values of 40 gsm, 42 gsm, 44 gsm, 46 gsm, 48 gsm, 50 gsm, 52 gsm, such as 54 gsm.

As used herein, the term “Caliper” refers to the thickness of a tissue product, web, sheet or ply, typically having units of microns (μm) and is measured as described in the Test Methods section below.

As used herein, the term “Sheet Bulk” refers to the quotient of the caliper (m) divided by the bone-dry basis weight (gsm). The resulting sheet bulk is expressed in cubic centimeters per gram (cc/g). Tissue products prepared according to the present disclosure may, in certain instances, have a sheet bulk greater than 8.0 cc/g, more preferably greater than 9.0 cc/g and still more preferably greater than 10.0 cc/g, such as from 8.0 to 12.0 cc/g.

As used herein, the term “Slough” generally refers to the undesirable sloughing off of bits of the tissue web when rubbed and is generally measured as described in the Test Methods section below. Slough is generally reported in terms of mass, such as milligrams (mg). While the Slough of tissue products may vary.

As used herein, the term “conventional creping composition” (also referred to herein as “a conventional creping adhesive”) generally refers to a composition applied to the surface of a creping cylinder during the manufacture of creped tissue products, the composition comprising a water soluble polymer selected from the group consisting of polyamidoamine-epichlorohydrin resin, polyamine-epichlorohydrin resin, polyvinyl alcohol, polyvinylamine, polyethyleneimine, polyacrylamide, polymethacrylamide, poly(acrylic acid), poly(methacrylic acid), poly(hydroxyethyl acrylate), poly(hydroxyethyl methacrylate), poly(n-vinyl pyrrolidinone), poly(ethylene oxide), hydroxyethyl cellulose, hydroxypropyl cellulose, guar gum, starch, agar, chitosan, alginic acid, carboxymethyl cellulose, highly branched polyamidoamines and their reaction product with epichlorohydrin and silyl-linked polyamidoamines.

As used herein, the term “Geometric Mean Tensile” (GMT) refers to the square root of the product of the machine direction tensile strength and the cross-machine direction tensile strength of the web and has the units g/3″.

As used herein the term “Stretch” refers to the percent elongation of the sample prior to breaking and may be specified according to the orientation of the sample as either “MD stretch” or “CD stretch”.

As used herein, the term “Slope” refers to the slope of the line resulting from plotting tensile versus stretch and is an output of the MTS TestWorks™ in the course of determining the tensile strength as described in the Test Methods section herein. Slope is reported in the units of grams (g) per unit of sample width (inches) and is measured as the gradient of the least-squares line fitted to the load-corrected strain points falling between a specimen-generated force of 70 to 157 grams (0.687 to 1.540 N) divided by the specimen width.

As used herein, the term “Geometric Mean Slope” (GM Slope) generally refers to the square root of the product of machine direction slope and cross-machine direction slope.

GM Slope=\sqrt{MD Tensile Slope (kg)×CD Tensile Slope (kg)}

As used herein, the term “TEA Index” refers the geometric mean tensile energy absorption (having units of g·cm/cm2) at a given geometric mean tensile strength (having units of g/3″) as defined by the equation:

$$TEA Index = \frac{GM TEA ( g \cdot \frac{cm}{{cm}^{2}} )}{GMT ( \frac{g}{{3}^{″}} )} \times 100$$

As used herein, the term “Stiffness Index” refers to the quotient of the geometric mean tensile slope divided by the geometric mean tensile strength.

$$Stiffness Index = \frac{\sqrt{MD Tensile Slope ( kg ) \times CD Tensile Slope ( kg )}}{GMT ( \frac{g}{{3}^{″}} )} \times 1000$$

As used herein, the term “TS750” generally refers to the smoothness of a tissue product surface measured using an EMTEC Tissue Softness Analyzer (“Emtec TSA”) (Emtec Electronic GmbH, Leipzig, Germany) interfaced with a computer running Emtec TSA software (version 3.19 or equivalent). The units of the TS750 value are dB V² rms, however, TS750 values are often referred to herein without reference to units. Generally, the TS750 value is the magnitude of the peak occurring at a frequency between 200 and 1,000 Hz, which is produced by vibration of the tissue membrane during the test procedure. Generally, a lower TS750 value is indicative of a smoother surface.

As used herein, the term “TS7” generally refers to the softness of a tissue product surface measured using an EMTEC Tissue Softness Analyzer (“Emtec TSA”) (Emtec Electronic GmbH, Leipzig, Germany) interfaced with a computer running Emtec TSA software (version 3.19 or equivalent). The units of the TS7 value are dB V² rms, however, TS7 values are often referred to herein without reference to units. Generally, the TS7 value is the magnitude of the peak occurring at a frequency between 6 and 7 kHz, which is produced by vibration of the tissue membrane during the test procedure. Generally, a lower TS7 value is indicative of a softer tissue product.

### Production of a Tissue Product

Tissue basesheets useful in forming tissue products may be formed using any one of several well-known manufacturing processes. For example, in certain implementations, tissue products may be produced by a conventional wet pressed (also referred to as “CTEC”) manufacturing process or a belt creped manufacturing process.

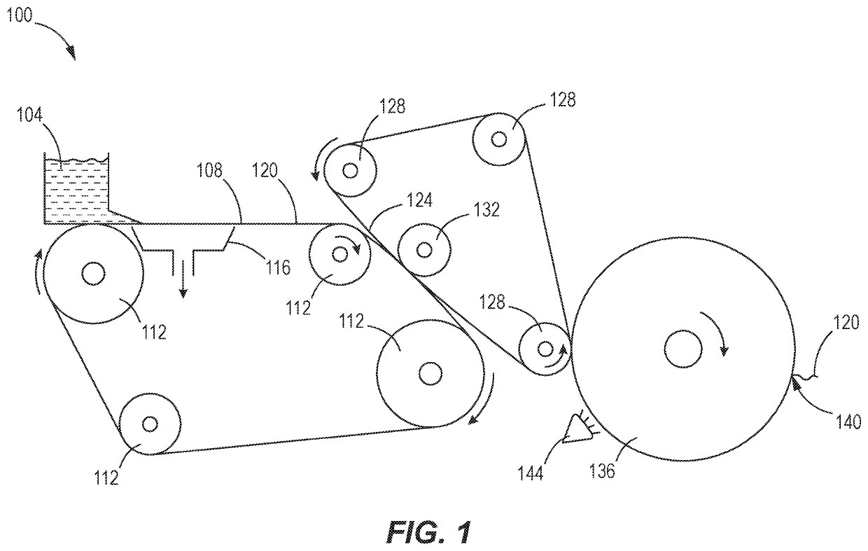

In a CTEC manufacturing process, an aqueous suspension of paper making fibers is formed into a tissue web, which is then adhered to a creping surface while wet. For example, referring to FIG. 1, a wet pressed creped tissue web forming system 100 is shown. In this implementation, a headbox 104 emits an aqueous suspension of fibers onto a forming fabric 108, which is supported and driven by a plurality of guide rolls 112. A vacuum box 116 is disposed beneath forming fabric 108 and is adapted to remove water from the fiber furnish to assist in forming a web 120. From forming fabric 108, the formed web 120 is transferred to a second fabric 124, which may be either a wire or a felt. The fabric 124 is supported for movement around a continuous path by a plurality of guide rolls 128. Also included is a pick-up roll 132 designed to facilitate transfer of web 120 from forming fabric 108 to second fabric 124. From second fabric 124, the web 120, in this implementation, is transferred to the surface of a rotatable heated dryer drum 136, such as a Yankee dryer.

In some implementations, an additive creping composition can be incorporated into the tissue web 120 by being applied (e.g., directly) to the surface of the dryer drum 136 for transfer onto one side of the tissue web 120. In this manner, the additive creping composition is used to adhere the tissue web 120 to the dryer drum 136. In this implementation, as the web 120 is carried through a portion of the rotational path of the dryer drum 136 surface, heat is imparted to the web 120 causing most of the moisture contained within the web 120 to be evaporated. For example, the creping surface can be heated to a temperature of from 20° C. to 150° C., such as from 100° C. to 130° C. In the implementation illustrated in FIG. 1, the tissue web is pressed against the creping surface while wet. For example, the tissue web, in one implementation, may have a consistency of from 10% to 30% solids, such as from 10% to 15% solids. In an alternative implementation, however, the tissue web may be partially dried prior to being pressed against the creping surface. In this implementation, for example, the tissue web may have a consistency from 30% to 70% solids.

The web 120 is then removed from dryer drum 136 by a creping blade 140. Creping the web 120 as it is formed further reduces internal bonding within the web 120 and increases softness. Applying the additive creping composition to the web 120 during creping, on the other hand, may improve other properties of the web 120. In some implementations, the additive creping composition can be sprayed onto the creping surface by a spraying device 144. In some implementations, the additive creping composition can be printed onto the surface, extruded onto the surface, or applied using any suitable technique.

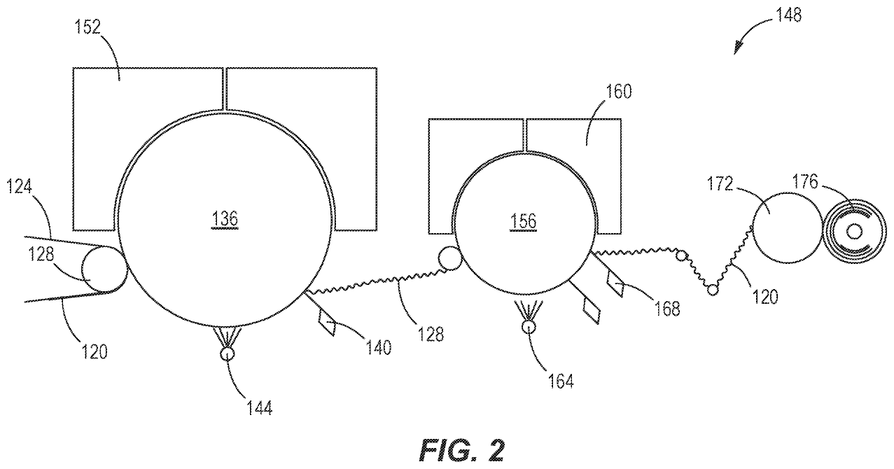

As shown in FIG. 2, another wet pressed creped tissue web forming system 148 is similar to the wet pressed creped tissue web forming system 100 discussed above and like reference numerals have been used to indicate similar elements with respect to the process illustrated in FIG. 1.

As shown in FIG. 2, the formed web 120 is transferred to the surface of the rotatable heated dryer drum 136, which may be a Yankee dryer. The guide roll 128 may, in one implementation, comprise a suction breast roll. To adhere the web 120 to the surface of the dryer drum 136, a creping adhesive may be applied to the surface of the dryer drum by the spraying device 144. The spraying device 144 may emit an additive creping composition made in accordance with the present disclosure.

As shown in FIG. 2, the web 120 is adhered to the surface of the dryer drum 136 and then creped from the drum using the creping blade 140. If desired, the dryer drum 136 may be associated with a hood 152. The hood 152 may be used to force air against the web 120.

Once creped from the dryer drum 136, the web 120 is then adhered to a second dryer drum 156. The second dryer drum 156 may include a heated drum surrounded by a hood 160. The second dryer drum 156 may be heated to a temperature of from 25° C. to 200° C., such as from 100° C. to 150° C.

To adhere the web 120 to the second dryer drum 156, a second spray device 164 may emit an adhesive onto the surface of the second dryer drum 156. In accordance with the present disclosure, for example, the second spray device 164 may emit an additive creping composition. The additive creping composition not only assists in adhering the tissue web 120 to the second dryer drum 156, but also is transferred to the surface of the web 120 as the web 120 is creped from the dryer drum 156 by a second creping blade 168. Once creped from the second dryer drum 156, the web 120 may, optionally, be fed around a cooling reel drum 172 and cooled prior to being wound on a reel 176.

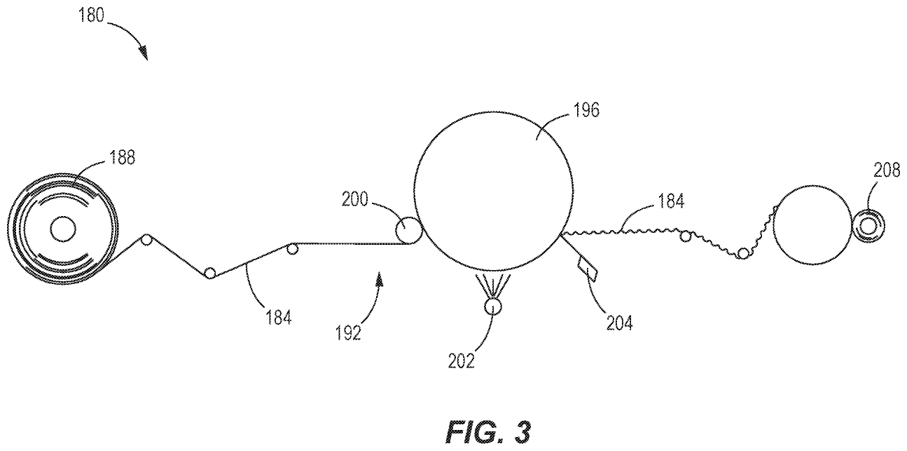

In the implementations shown in FIG. 1 and in FIG. 2, the creping process is directly incorporated into the process for forming the web. These implementations may be considered “in-line” processes. In an alternative implementation, however, the base sheet may be formed and then subjected to the creping process. For example, referring to FIG. 3, still another wet pressed creped tissue web forming system 180 for applying the additive creping composition to one side of a base sheet in accordance with the present disclosure is illustrated. As shown, in this implementation, a formed base sheet 184 is unwound from a roll 188 and fed into an off-line process 192, although the application method may also be installed in-line.

As illustrated in FIG. 3, the base sheet 184 is pressed against a dryer drum 196 by a press roll 200. A spray device 202 applies the additive creping composition of the present disclosure to the surface of the dryer drum. The additive creping composition thus not only adheres the base sheet 184 to the surface of the dryer drum 196, but also transfers to the base sheet 184 as the base sheet 184 is creped from the drum using a creping blade 204. Once creped from the dryer drum 196, the base sheet 184 is wound into a roll 208.

In the implementation illustrated in FIG. 3, a preformed base sheet is creped from the rotating cylinder or drum 196 when processing tissue webs, for example, the tissue web is generally dry when adhered to the creping surface. For example, the tissue web can have a consistency of greater than 95%.

In the implementation illustrated in FIG. 3, the creping surface may be at ambient temperature or may be heated. It should be understood, however, that it may not be necessary to heat the creping surface in the implementation illustrated in FIG. 3 depending upon the additive creping composition that is used. In some implementations, the additive creping composition itself may be preheated prior to being applied to the creping surface.

The amount of surface area that the additive creping composition covers on the base sheet when applied to the base sheet can vary. In general, for example, the additive creping composition covers at least 10% of the surface of one side of the base sheet. For example, the additive creping composition may cover from 20% to 100% of the surface of the base sheet, such as from 20% to 90%, such as from 20% to 75%.

In some implementations, only one side of the base sheet comprises the additive creping composition. It should be understood, however, that both sides of the base sheet may comprise the additive creping composition in accordance with the present disclosure. For example, once one side of the base sheet is creped from a creping surface, the opposite side can be similarly adhered to a creping surface by the additive creping composition.

In some implementations, an additive creping composition is incorporated into a sheet-like product, such as a tissue web. In addition to adhering the base sheet to the creping surface, the additive creping composition also transfers to the base sheet in amounts sufficient to increase the basis weight, such as more than 1% by weight. In this manner, sufficient amounts of the additive creping composition can be transferred to a sheet in order to improve one or more properties of the base sheet. In addition, creping the base sheet may also increase the softness and bulk of the base sheet.

The composition of the base sheet produced according to the present disclosure can vary depending upon the particular application and the desired result. In some implementations, the base sheet includes a tissue web containing cellulosic fibers. In some implementations, the base sheet includes nonwoven webs containing cellulosic fibers and synthetic fibers, such as hydroentangled webs and coform webs. In some implementations, nonwoven webs, such as meltblown webs and spunbond webs, are used. In some implementations, woven materials and knitted materials are used in the process as long as the materials are capable of being adhered to a creping surface and removed.

In some implementations, the tissue webs are creped using a conventional creping composition. To achieve the desired creping efficiency and tissue product properties, tissue webs may be creped using a conventional creping composition comprising at least one, and more preferably at least two, water-soluble polymers. For purposes herein, “water-soluble” means that the polymers dissolve completely in water to give a solution as opposed to a latex, dispersion, or suspension of undissolved particles. Suitable water soluble polymers may be selected from the group consisting of polyamidoamine-epichlorohydrin resin, polyamine-epichlorohydrin resin, polyvinyl alcohol, polyvinylamine, polyethyleneimine, polyacrylamide, polymethacrylamide, poly(acrylic acid), poly(methacrylic acid), poly(hydroxyethyl acrylate), poly(hydroxyethyl methacrylate), poly(n-vinyl pyrrolidinone), poly(ethylene oxide), hydroxyethyl cellulose, hydroxypropyl cellulose, guar gum, starch, agar, chitosan, alginic acid, carboxymethyl cellulose, highly branched polyamidoamines and their reaction product with epichlorohydrin and silyl-linked polyamidoamines.

In some implementations, the conventional creping composition comprises a water-soluble polymer such as an aqueous solution comprising a polyether, a polyamide, or a mixture of one or both with another water-soluble polymer. Suitable polyethers include (poly)ethylene oxide, (poly)propylene oxide, ethylene oxide/propylene oxide copolymers, (poly)tetra methylene oxide, poly vinyl methyl ether, and the like. Suitable polyamides include (poly)vinylpyrrolidone, (poly)ethyl oxazoline, (poly)amidoamine, (poly)acrylamide, polyethylene imine, and the like. Number of average molecular weights for these components should be from 10,000 to 500,000.

In certain implementations tissue products may be formed from one or more basesheets, which may comprise a single homogenous or blended layer, or be multi-layered. In those instances where the basesheet is multi-layered it may comprise two, three, or more layers. For example, the basesheet may comprise three layers such as first and second outer layers and a middle layer disposed there between. The layers may comprise the same or different fiber types. For example, the first and second outer layers may comprise short, low coarseness wood pulp fibers, such as hardwood kraft pulp fibers, and the middle layer may comprise long, low coarseness wood pulp fibers, such as northern softwood kraft pulp fibers.

In those instances where the web comprises multiple layers, the relative weight percentage of each layer may vary. For example, the web may comprise first and second outer layers and a middle layer where the first outer layer comprises from 25 to 35 weight percent of the layered web, the middle layer comprises from 30 to 50 weight percent of the layered web and the second outer layer comprises from 25 to 35 weight percent of the layered web.

In some implementations, a forming multi-layered basesheet is produced by dispersing a dilute aqueous suspension of papermaking fibers from a headbox having an upper headbox wall and a lower headbox wall and first and second dividers. In this manner the headbox may be used to form a basesheet having two outer layers and a middle layer, where each of the layers may comprise the same or different papermaking fibers.

To form the multi-layered basesheet, an endless traveling forming fabric, suitably supported and driven by rolls, receives the layered papermaking stock issuing from headbox. Once retained on fabric, the layered fiber suspension passes water through the fabric. Water removal is achieved by combinations of gravity, centrifugal force and vacuum suction depending on the forming configuration.

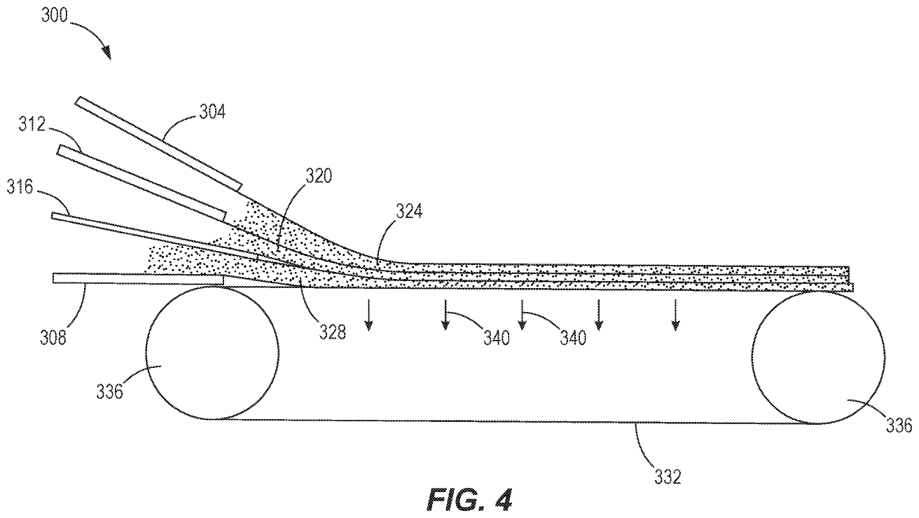

For example, referring to FIG. 4, one implementation of a device for forming a multi-layered stratified pulp furnish is illustrated. As shown, a three-layered headbox 300 generally includes an upper head box wall 304 and a lower head box wall 308. The headbox 300 further includes a first divider 312 and a second divider 316, which separate three fiber stock layers.

Each of the fiber layers comprise a dilute aqueous suspension of papermaking fibers. The particular fibers contained in each layer generally depend upon the product being formed and the desired results. For example, the fiber composition of each layer may vary depending upon whether a bath tissue product, facial tissue product or paper towel is being produced. In one implementation, for example, middle layer 320 contains southern softwood kraft fibers either alone or in combination with other fibers such as high yield fibers. Outer layers 324 and 328, on the other hand, contain softwood fibers, such as northern softwood kraft. In some implementations, the middle layer may contain softwood fibers for strength, while the outer layers may comprise hardwood fibers, such as eucalyptus fibers, for a perceived softness.

An endless traveling forming fabric 332, suitably supported and driven by rolls 336, receives the layered papermaking stock issuing from headbox 300. Once retained on fabric 332, the layered fiber suspension passes water through the fabric as shown by the arrows 340. Water removal is achieved by combinations of gravity, centrifugal force and vacuum suction depending on the forming configuration.

The basis weight of tissue webs made in accordance with the present disclosure can vary depending upon the final product. In general, the basis weight of the tissue products may vary from 10 gsm to 110 gsm, such as from 20 gsm to 90 gsm. For bath tissue, for example, the basis weight may range from 20 gsm to 60 gsm, such as 39 gsm to 43 gsm.

The tissue web bulk may also vary from 3 cc/g to 20 cc/g, such as from 8 cc/g to 15 cc/g.

In some implementations, when incorporating a tissue web made according to the present disclosure into a multi-ply product, it may be desirable to only have the additive creping composition on one side of the tissue web by applying the creping composition to the Yankee dryer drum and creping the side of the web that is in contact with the creping composition and the drum. The creped side of the web is then used to form an exterior surface of a multi-ply product. The side of the web that does not include the additive creping composition, on the other hand, is attached by any suitable means to one or more plies.

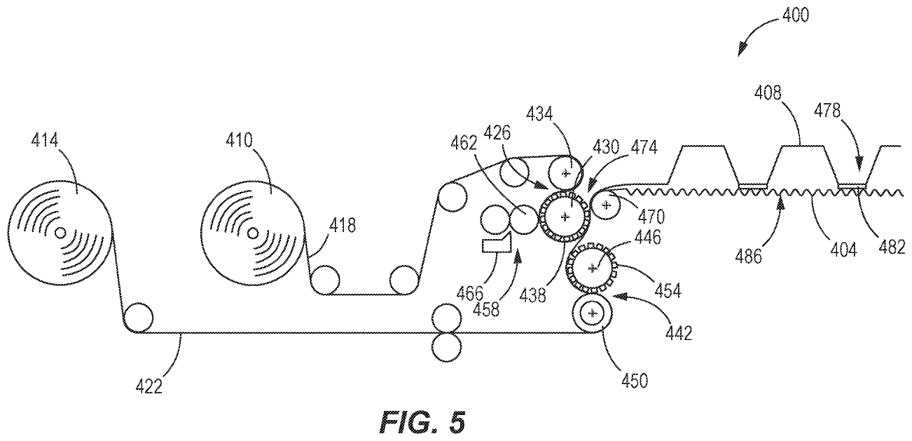

As shown in FIG. 5, a multi-ply tissue product in the form of a two-ply tissue product 400 comprises an embossed bottommost ply 404 and an embossed uppermost ply 408. Generally, the process begins by unwinding first and second parent rolls 410, 414 comprising first and second tissue webs 418, 422, which will ultimately form the first and second tissue plies 404, 408. In certain instances, one or more of the webs may be optionally pre-embossed in a first pre-embossing station or be subjected to other converting steps, such as calendering or slitting prior to being embossed and plied into a multi-ply product.

The embossing operation utilizes an embossing roll and an anvil that create a nip pressure, when engaged with one another to form an embossing nip, sufficient to create deformations (embossments) in a fibrous structure present within the embossing nip. The embossing roll generally comprises a plurality of protrusions on its outer surface where the protrusions form an embossing pattern. For example, as illustrated in FIG. 5, the first tissue web 418 is directed into the first nip 426 of a first embossing station that includes a first embossing roll 430 and an anvil roll 434. In the nip 426 between the first embossing roll 430 and anvil roll 434 the uppermost ply 408 receives a first embossing pattern by being brought into contact with first protuberances 438 disposed on the surface of the first embossing roll 430.

In some implementations, the embossing roll 430 is made of metal, especially steel, hard plastics materials or hard rubber. In case of plastics, very hard plastic material can be preferred, alternatively a resin material is also possible. In some implementations, the anvil roll 434 is made of rubber like EPDM or NBR (acrylonitrile-butadiene rubber), paper or steel. The rubber can have a hardness of 20 to 85 Shore A, such as 50 to 75 Shore A.

The embossing roll 430 may be made by any suitable process known in the art. Non-limiting examples of suitable processes include laser engraving hard plastic (ebonite) or ceramic or other material suitable for laser ablation to remove material and create embossing elements, chemical engraving of steel or other materials to remove material and create embossing elements, machining aluminum or steel or other metals to remove material and create embossing elements, metallizing processes to build up embossing elements, sintering processes to build up embossing elements and/or other means known in the art to remove material or build up material and achieve a surface topography with the desired pattern and clearances between mating embossing elements.

The second tissue web 422 is unwound from a second parent roll 414 and introduced into a nip 442 formed between a second embossing roll 446 and a second anvil roll 450 which form a second embossing station. The same materials as described above with reference to the first embossing roll 430 and the first anvil roll 434 also apply to the second embossing roll 446 and the second anvil roll 450. Upon passing through the embossing nip 442, the second tissue web 422 is provided with a second embossing pattern, which is preferably different than the pattern applied by the first embossing station. The embossing pattern is imparted to the second tissue web 422 by contacting it with a plurality of second protuberances 454 disposed on the second embossing roll 446.

The process may further comprise an application device 458, which may include an applicator roll 462 for applying functional substances 466 to the first tissue web 418 after it exits the first embossing nip 426. Such applicator devices are well known in the art and are commonly used for the application of adhesives or colored substances. For example, the process may comprise an applicator roll 462 which contacts the protrusions on the first tissue web 418 while supported by the first embossing roll 430.

In a particular implementation, an adhesive is applied by the application device 458, which may comprise an adhesive applicator roll running against the first embossing roll 430. For laminating the single webs of material together, different types of adhesive can be used. Suitable adhesives are, inter alia, glue on the basis of starch or modified starch like, for example, methyl cellulose or carboxylated methyl cellulose, and adhesively acting polymers on the basis of synthetic resins, caoutchouc, polypropylene, polyisobutylene, polyurethane, polyacrylates, polyvinyl acetate or polyvinyl alcohol. Such adhesives can also contain coloring agents in order to improve the optical appearance of the finished products. Frequently, water-based glues are used for laminating together paper layers.

In some implementations, the embossing patterns applied to the first and second tissue webs 418, 422 do not need to be registered with one another to provide the finished tissue product with improved properties, such as improved sheet bulk. In this way, the first and second plies do not need to be combined to form a sub-unit (e.g., the bottom ply embossments nesting into a structure formed by the embossing pattern of the top ply). Rather than being nested (i.e., one embossing pattern at least partially surrounding another), the embossing patterns are unregistered. This simplifies the manufacturing process as there is no need to operate the first and second embossing rolls 430, 446 in registration or synchronized with one another.

The embossed first and second tissue webs 418, 422 are joined together by a marrying roll 470 that runs against the first embossing roll 430. In this manner, the embossed first tissue web 418, which may have an adhesive applied to its surface by an applicator roll 462, is laminated to the second embossed tissue web 422 in a third nip 474 formed between the first embossing roll 430 and the marrying roll 470.

The resulting multi-ply tissue product 400 includes the uppermost ply 408 and the bottommost ply 404. The first upper ply 408 has a plurality of embossments 478 that protrude inward towards the bottommost ply 404. In certain instances, such as illustrated in FIG. 5, the uppermost ply 408 may be attached to the bottommost ply 404 by an adhesive 482 disposed therebetween.

Generally, at least a portion of the uppermost ply embossments 478 are arranged to form an open pattern, as discussed above. The bottommost ply 404 also comprises a plurality of embossments 486, a portion of which are micro-embossments. While both the uppermost and bottommost plies 404, 408 include embossments, particularly embossments arranged in a pattern, the embossments are not arranged such that the patterns are registered with one another.

Further, in some implementations, it may be preferred to provide the uppermost ply 408 with a plurality of continuous, curvilinear line elements formed from embossments having a depth of 300 picometers (pm) or more, such as 325 pm or more, such as 350 pm or more, such as from 300 pm to 500 μm. Conversely, the bottommost ply 404, is provided with a plurality of micro-embossments, which in certain preferred instances are discrete dot embossments disposed at a density of at least 25 embossments/cm². Generally, the micro-embossments are disposed on the bottommost ply in a pattern, however, the pattern does not necessarily register with the pattern of embossments disposed on the uppermost ply. Despite the lack of registration between the embossing patterns on each ply, the resulting tissue products have improved properties, such as improved sheet bulk and softness.

### Multi-Ply Tissue Generated by a Patterned Creping Blade

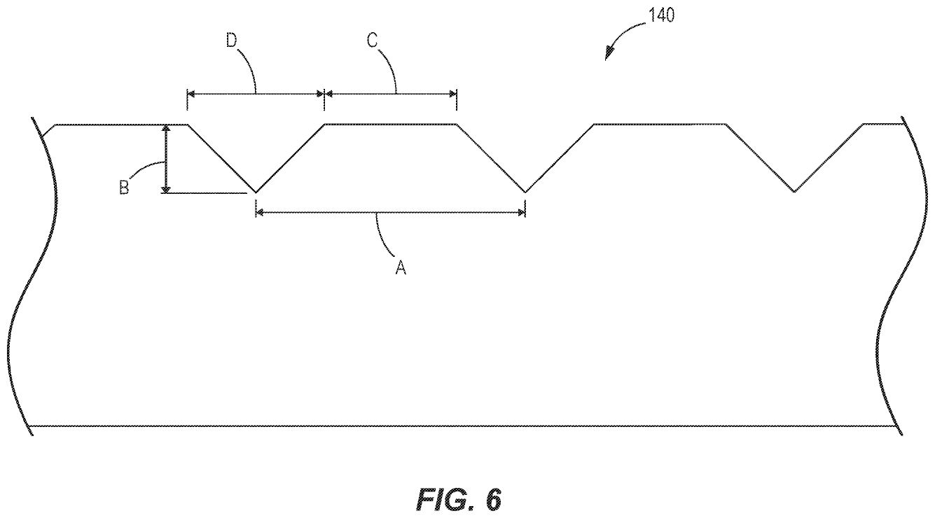

As shown in FIG. 6, a textured creping blade 140 can be utilized in any of the wet pressed creped tissue web forming systems 100, 148, 180 discussed above. The textured creping blade 140 defines a blade indentation spacing A, a blade indentation depth B, a blade width C, and an indentation width D. The textured creping blade 140 includes V-shaped indentations and a flat blade surface. In some implementations, the textured creping blade 140 defines an undulating shape, a curved blade surface, concave or convex indentations, square indentations, or another shape profile defining a non-straight edged creping blade. In some implementations, the textured creping blade 140 is developed by BTG Instruments. For example, see U.S. Pat. No. 6,425,983.

In some implementations, the blade indentation spacing A is 500 μm to 2000 μm. In some implementations, the textured creping blade 140 is a low textured blade and the blade indentation spacing A is 500 μm. In some implementations, the textured creping blade 140 is a medium textured blade and the blade indentation spacing A is 1000 μm. In some implementations, the textured creping blade 140 is a high textured blade and the blade indentation spacing A is 2000 μm.

In some implementations, the blade indentation depth B is 55 μm to 350 μm. In some implementations, the textured creping blade 140 is a low textured blade and the blade indentation depth B is 55 μm. In some implementations, the textured creping blade 140 is a medium textured blade and the blade indentation depth B is 110 μm. In some implementations, the textured creping blade 140 is a high textured blade and the blade indentation depth B is 350 μm.

In some implementations, the blade width C is 227 μm to 949 μm. In some implementations, the textured creping blade 140 is a low textured blade and the blade width C is 227 μm. In some implementations, the textured creping blade 140 is a medium textured blade and the blade width C is 467 μm. In some implementations, the textured creping blade 140 is a high textured blade and the blade width C is 949 μm.

In some implementations, the indentation width D is 273 μm to 1051 μm. In some implementations, the textured creping blade 140 is a low textured blade and the indentation width D is 273 μm. In some implementations, the textured creping blade 140 is a medium textured blade and the indentation width D is 533 μm. In some implementations, the textured creping blade 140 is a high textured blade and the indentation width D is 1051 μm.

The textured creping blade 140 is used to create a tissue product having a visually apparent texture. The appearance of a visual texture in a tissue sheet can cue a consumer to expected benefits of softness or function, as well as create a tissue that feels thicker and more durable. Existing systems used to create a visually textured tissue product may utilize an un-creped through-air-drying process, which molds a wet sheet using a textured through-air-drying fabric. Bath tissues are often produced using a wet pressed creped tissue web forming system that includes a flat or linear creping blade, and this process generally produces flat, smooth tissue. Existing systems may attempt to add texture to a web produced with a flat creping blade via an embossing process, but the additional embossing step is cost intensive, both for capital investment and ongoing operation. Additionally, the aesthetic appearance of the embossed texture is diminished due to the high forces imparted by the wound roll. In some implementations, a texture may be imparted to a bath tissue via a through-air-drying (TAD) fabric with a textured surface. The TAD fabric results in a significantly different web structure and different characteristics that the web produced using the textured creping blade 140.

The wet pressed creped tissue web forming systems 100, 148, 180 utilizing the textured creping blade 140 imparts texture using an existing manufacturing footprint (e.g., a tissue machine or multi-folder). As the tissue is creped off the dryer, the sheet encounters the uneven creping edge of the textured creping blade 140, and the uneven edge forms a structure of ridges and valleys that are oriented in the machine direction, like a corduroy pattern.

In some implementations, a method of producing a multi-ply tissue product includes applying creping composition to a Yankee dryer drum, applying a first tissue ply to the Yankee dryer drum, creping the first tissue ply from a Yankee dryer drum with a textured creping blade, applying a second tissue ply to the Yankee dryer drum, creping the second tissue ply from the Yankee dryer drum with the textured creping blade, and marrying the creped first tissue ply and the creped second tissue ply to create a multi-ply tissue product having a TS750 value greater than 45 and a TS7 value of less than 14. In some implementations, the creping composition is applied to the Yankee dryer drum ahead of applying a first tissue ply and ahead of applying a second tissue ply to the Yankee dryer drum. In some implementations, the creping composition is applied to the Yankee dryer drum and not directly onto the first tissue ply and/or the second tissue ply. In some implementations, the multi-ply tissue product has a caliper of 375 μm to 630 μm. For example, the multi-ply tissue product has a caliper of 380 μm to 580 μm. In some implementations, the creping composition is a conventional creping composition. In other implementations, the creping composition is an olefin polymer creping composition. For example, in some implementations, the multi-ply tissue product produced by this method is a bath tissue.

### Examples

A trial using the textured creping blade 140 was successful at generating increased thickness in a sheet with visible texture. The trial utilized three different textured creping blades 140: a low textured blade, a medium textured blade, and a high textured blade.

The use of the textured creping blade 140 generated increased texture at each level of texture (e.g., low textured blade, medium textured blade, high textured blade). The Yankee dryer systems discussed above were used to create 1-ply textured sheets that were then married together into a 2-ply bath tissue product. In some implementations, each 1-ply sheet can be calendered. In some implementations, the 2-ply bath tissue product is further embossed over the visual texture imparted by the textured creping blade 140. For example, in some implementations, a nip roller and a microdot embossing sleeve is used to impart a microdot structure to the 1-ply sheets. In the trials, a 24 mm nip width and a 29 mm nip width were used. The trials also examined a 30 dot embossing sleeve and a 60 dot embossing sleeve. The results of the trials show that the caliper and other favorable characteristics of webs produced using the textured creping blade 140 survived the marrying and embossing processes to provide a multi-ply tissue product (e.g., a bath tissue) with characteristics that are favorable when compared to a similar sheet produced with a flat creping blade. In some implementations, the 30 dot sleeve may increase caliper and/or bulk of the resulting sheets when compared to the 60 dot sleeve.

In some implementations, the processes and structures discussed herein can be utilized in a single ply tissue product. For example, a single ply bath tissue product can be produced using the textured creping blade 140.

In some implementations, a multi-ply tissue product (e.g., a bath tissue) includes two or more tissue plies, the multi-ply tissue product defining a first outer surface and a second outer surface opposite the first outer surface, and at least the first outer surface defining a three-dimensional surface topography including a plurality of ridges extending in a machine direction and separated by valleys. In some implementations, the second outer surface also defines a three-dimensional surface topography including a plurality of ridges extending in the machine direction and separated by valley. The ridges defined on the first and second outer surfaces may have the same or different dimensions, density, and/or spacing from each other. In some implementations, the three-dimensional surface topography for each ply is produced by a textured creping blade.

Table 1 below shows the textured blade designs that were used in the trials.

TABLE 1

| | Ind. Spacing | | Depth |
|---|---|---|---|
| Blade Name | (μm) | Ind/inch | (μm) |
| Low Texture Blade | 500 | 50 | 55 |
| Medium Texture Blade | 1000 | 25 | 110 |
| High Texture Blade | 2000 | 12.7 | 350 |

In some implementations, the texture creping blade 140 results in each of the plurality of ridges on the tissue product having a height of 50 μm to 355 μm. For example, the plurality of ridges can have a height of 55 μm, 110 μm, or 350 μm. In some implementations, each of the plurality of ridges has a height that is smaller than the blade indentation height B. The height of each ridge is measured from a peak of the ridge to a lowest point of an adjacent valley.

In some implementations, the texture creping blade 140 results in each of the plurality of ridges on the tissue product being spaced apart from an adjacent ridge by a distance of 500 μm to 2000 μm. For example, each of the plurality of ridges can be spaced apart from the adjacent ridge by a distance of 500 μm, 1000 μm, or 2000 μm. In some implementations, the plurality of ridges includes 50 ridges per inch to 12 ridges per inch.

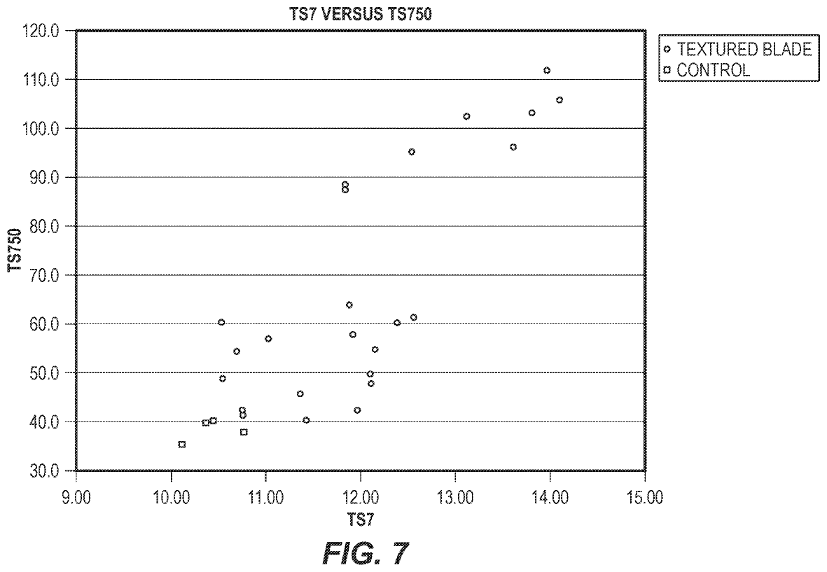

The trial results are shown in FIG. 7. Use of the textured creping blade 140 creates a three-dimensional surface texture, measured as TS750, with only a moderately negative effect on softness, measured as TS7. The Table 2, shown below, includes TS7 and TS750 for two-ply tissue samples converted after being produced with different textured and control (flat) creping blades. In some implementations, a top sheet and a bottom sheeted are married together to form the multi-ply tissue product.

In some implementations, the multi-ply tissue product has a TS750 value of 40 or greater, such as 42 or greater, such as 45 or greater, such as 50 or greater, such as from 40 to 115, such as from 42 to 100. In some implementations, the multi-ply tissue product has a TS7 value of less than 15, such as less than 14, such as less than 13, such as less than 12, such as from 10 to 15, such as from 10 to 13. In some implementations, the multi-ply tissue product has a TS7 value of less than 13. In some implementations, when a low or medium textured creping blade 140 is used, the resulting TS750 is between 40 and 65 and the resulting TS7 is less than 12.

The slough produced during the trial conducted with the conventional creping composition did not experience a significant increase. In some implementations, the multi-ply tissue product is produced with under 3 milligrams of slough, such as from 2 milligrams to 3 milligrams of slough.

TABLE 2

| Sample | Sample | | | Slough- |
|---|---|---|---|---|
| No. | Description | TS7 | TS750 | mg |
| 1 | Control Blade, 24 mm | 10.11 | 35.4 | 2.5 |
| | Bottom Nip, 60 Dot | | | |
| | Sleeve | | | |
| 2 | Low Texture Blade, | 11.96 | 42.5 | 1.5 |
| | 24 mm Bottom Nip, | | | |
| | 60 Dot Sleeve | | | |
| 3 | Medium Texture Blade, | 12.38 | 60.2 | 2.1 |
| | 24 mm Bottom Nip, | | | |
| | 60 Dot Sleeve | | | |
| 4 | High Texture Blade, | 13.81 | 103.2 | 2.6 |
| | 24 mm Bottom Nip, | | | |
| | 60 Dot Sleeve | | | |
| 5 | Control Blade, 29 mm | 10.77 | 37.9 | 2.3 |
| | Bottom Nip, 60 Dot | | | |
| | Sleeve | | | |
| 6 | Low Texture Blade, | 11.43 | 40.3 | 2.4 |
| | 29 mm Bottom Nip, | | | |
| | 60 Dot Sleeve | | | |
| 7 | Medium Texture Blade, | 12.15 | 54.8 | 2.2 |
| | 29 mm Bottom Nip, | | | |
| | 60 Dot Sleeve | | | |
| 8 | High Texture Blade, | 13.97 | 111.8 | 3.0 |
| | 29 mm Bottom Nip, | | | |
| | 60 Dot Sleeve | | | |
| 9 | Low Texture Blade, | 12.10 | 47.9 | 1.4 |
| | 24 mm Bottom Nip, | | | |
| | 30 Dot Sleeve | | | |
| 10 | Low Texture Blade, | 12.10 | 49.9 | 1.6 |
| | 29 mm Bottom Nip, | | | |
| | 30 Dot Sleeve | | | |
| 11 | Medium Texture Blade, | 12.55 | 61.3 | 1.8 |
| | 24 mm Bottom Nip, | | | |
| | 30 Dot Sleeve | | | |
| 12 | Medium Texture Blade, | 11.88 | 63.9 | 1.8 |
| | 29 mm Bottom Nip, | | | |
| | 30 Dot Sleeve | | | |
| 13 | High Texture Blade, | 13.61 | 96.2 | 1.9 |
| | 24 mm Bottom Nip, | | | |
| | 30 Dot Sleeve | | | |
| 14 | High Texture Blade, | 14.10 | 105.8 | 2.2 |
| | 29 mm Bottom Nip, | | | |
| | 30 Dot Sleeve | | | |

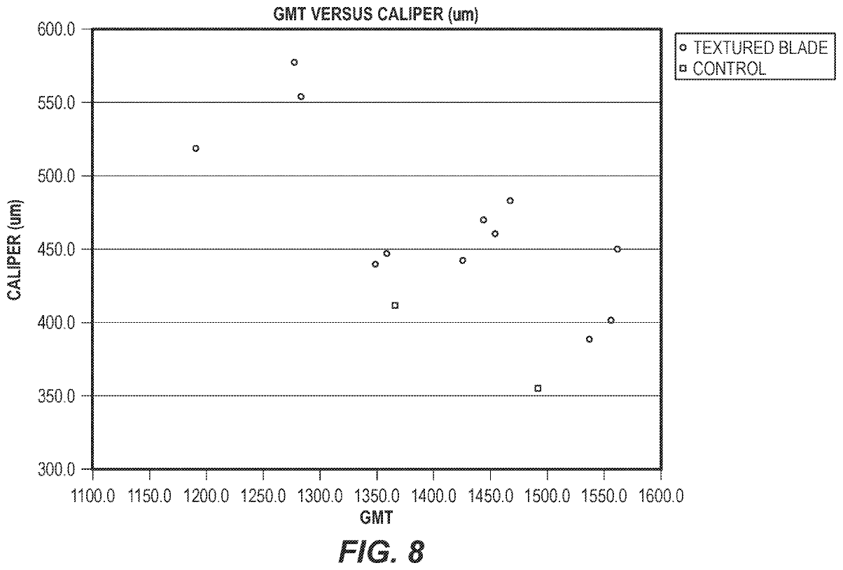

As shown in FIG. 8, the caliper of the sheets produced using the textured creping blade 140 is generally greater than sheets produced with a flat creping blade (Control) while providing a similar GMT. Table 3, shown below, provides trial data for basis weight of the multi-ply tissue product, GMT of the multi-ply tissue product, a summed caliper of the two base sheets before they have been converted to form the multi-ply tissue product, and caliper of the multi-ply tissue product in microns of the samples listed in Table 2.

TABLE 3

| | | | 2-ply | Converted |
|---|---|---|---|---|
| | | | unmarried | Product |
| Sample | BDBW | GMT | caliper | Caliper |
| No. | (gsm) | (g/3″) | (microns) | (microns) |
| 1 | 41.2 | 1490.2 | 333.0 | 355.6 |
| 2 | 41.0 | 1535.7 | 417.0 | 388.6 |
| 3 | 41.1 | 1555.0 | 432.0 | 401.3 |
| 4 | 40.6 | 1560.3 | 625.0 | 449.6 |
| 5 | 41.4 | 1365.0 | 333.0 | 411.5 |
| 6 | 40.2 | 1348.4 | 417.0 | 439.4 |
| 7 | 41.0 | 1424.9 | 432.0 | 442.0 |
| 8 | 40.2 | 1443.2 | 625.0 | 469.9 |
| 9 | 41.1 | 1358.6 | 417.0 | 447.0 |
| 10 | 40.9 | 1190.8 | 417.0 | 518.2 |
| 11 | 41.3 | 1453.2 | 432.0 | 459.7 |
| 12 | 41.3 | 1282.9 | 432.0 | 553.7 |
| 13 | 41.2 | 1466.0 | 625.0 | 482.6 |
| 14 | 41.0 | 1277.5 | 625.0 | 576.6 |

The trial data shown above indicates that caliper and other characteristics are maintained through processing into the multi-ply tissue product (e.g., embossing, marrying, etc.). Table 4, shown below, illustrates how each sample listed in Table 2 compared to the related control (flat) creping blade. The caliper degradation shows how much the caliper reduced as a percentage compared to the summed caliper of the two base sheets before they were married together. The caliper increase versus control shows how much as a percentage the caliper increased compared to a similarly produced tissue product made with a flat creping blade. As shown in the table, use of the texture creping blade 140 improved the caliper significantly and that caliper survived the marrying process well.

While the GMT may vary amongst tissue products prepared according to the present disclosure, in certain implementations, tissue products may have a GMT greater than 900 g/3″, such as greater than 1,000 g/3″, such as greater than 1,100 g/3″, such as greater than 1,200 g/3″, such as greater than 1,300 g/3″, such as greater than 1,400 g/3″, such as greater than 1,500 g/3″, such as from 900 g/3″ to 1,600 g/3″, such as from 1,000 g/3″ to 1,500 g/3″.

While the Converted Product Caliper may vary amongst tissue products prepared according to the present disclosure, in certain implementations, tissue products may have a Converted Product Caliper greater than 388 microns, such as greater than 400 microns, such as greater than 450 microns, such as greater than 500 microns, such as greater than 550 microns, such as from 388 microns to 600 microns, such as from 400 microns to 575 microns.

TABLE 4

| | Caliper | Caliper increase |
|---|---|---|
| Sample No. | degradation | versus control |
| 1 | −6.8% | |
| 2 | 6.8% | 8.5% |
| 3 | 7.1% | 11.4% |
| 4 | 28.1% | 20.9% |
| 5 | −23.6% | |
| 6 | −5.4% | 13.9% |
| 7 | −2.3% | 14.4% |
| 8 | 24.8% | 19.5% |

In addition, Table 5, shows the results of the trial of the GM TEA, the TEA Index, the GM Slope, and the Stiffness Index for products produced with various textured blades corresponding to the sample numbers listed above in Table 2.

TABLE 5

| | GM TEA | TEA Index | GM Slope | Stiffness |
|---|---|---|---|---|
| Sample No. | (g · cm/cm²) | (g · cm/cm²) | (grams) | Index |
| 1 | 11.4 | 7.6 | 12396 | 8.3 |
| 2 | 10.1 | 7.4 | 12783 | 9.4 |
| 3 | 12.1 | 8.9 | 10531 | 7.8 |
| 4 | 12.5 | 8.2 | 12503 | 8.1 |
| 5 | 10.2 | 8.5 | 9887 | 8.3 |
| 6 | 10.3 | 7.6 | 12456 | 9.2 |
| 7 | 11.3 | 7.8 | 11918 | 8.2 |
| 8 | 12.0 | 7.7 | 12626 | 8.1 |
| 9 | 10.0 | 7.8 | 10716 | 8.4 |
| 10 | 11.1 | 7.8 | 11636 | 8.2 |
| 11 | 11.7 | 8.0 | 12166 | 8.3 |
| 12 | 12.1 | 7.8 | 11591 | 7.4 |
| 13 | 10.0 | 7.8 | 10664 | 8.3 |
| 14 | 11.1 | 7.7 | 10918 | 7.6 |

While the GM Slope may vary amongst tissue products prepared according to the present disclosure, in certain implementations, tissue products may have a GM Slope less than 14 kg, such as less than 12 kg or less than 11 kg, such as from 9 kg to 14 kg or from 9.8 kg to 12.8 kg.

While the Stiffness Index may vary amongst tissue products prepared according to the present disclosure, in certain implementations, tissue products may have a Stiffness Index less than 10, such as less than 9, or less than 8, such as from 7 to 10 or from 7.4 to 9.4.

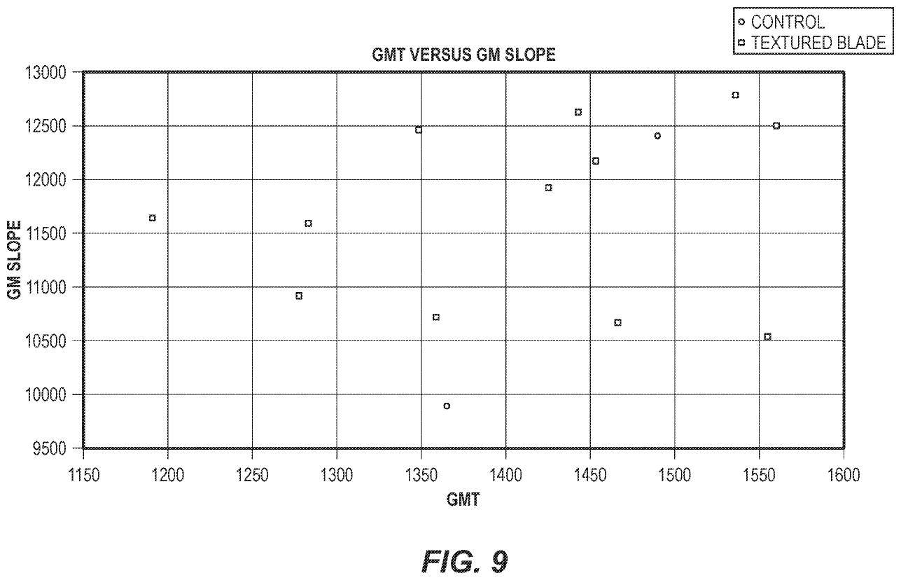

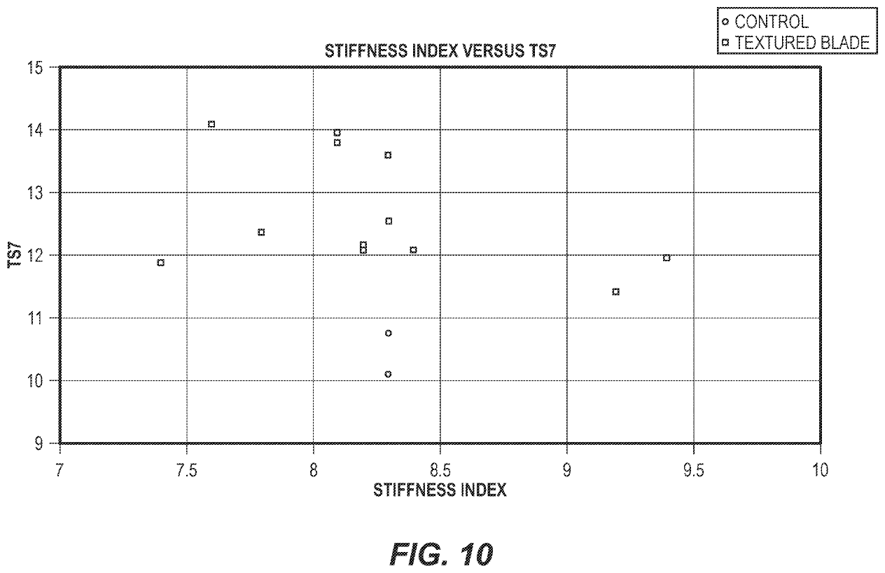

As shown in FIG. 9, a graph shows the relationship between GMT and the Stiffness Index. As shown in FIG. 10, the tissue products produced using the textured creping blades exhibit an increased TS7 when compared to the control.

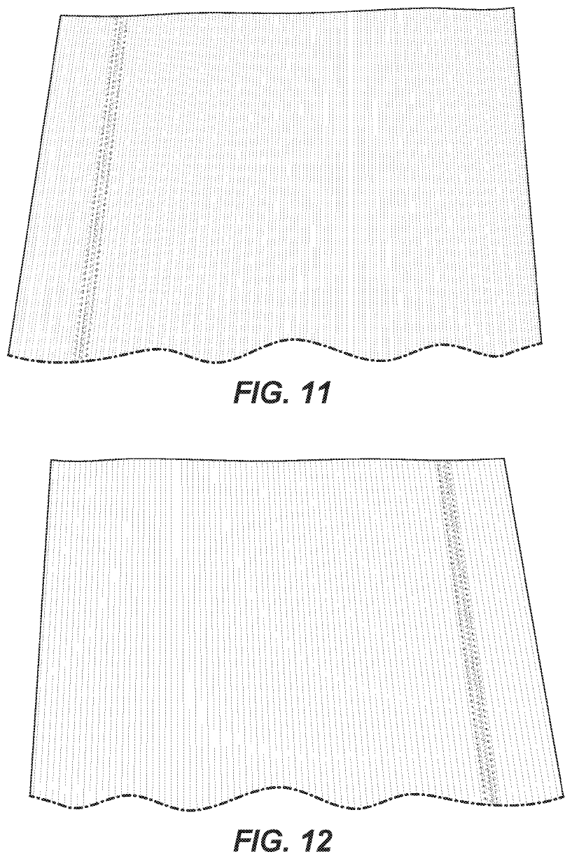

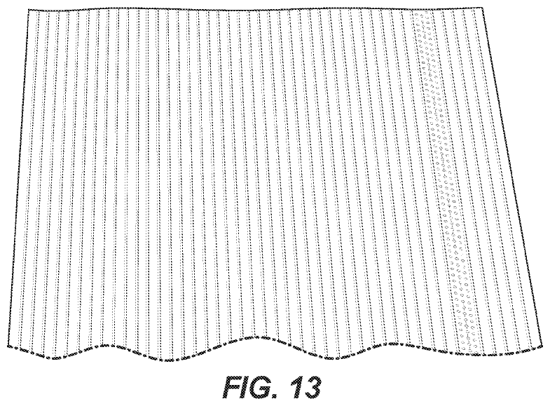

As shown in FIGS. 11-13, the textured creping blade 140 creates a multi-ply tissue product with visual texture. FIG. 11 shows a tissue product (e.g., a bath tissue) produced using a low texture creping blade. FIG. 12 shows a tissue product (e.g., a bath tissue) produced using a medium texture creping blade. FIG. 13 shows a tissue product (e.g., a bath tissue) produced using a high texture creping blade.

### Test Methods

Basis weight is tested by first conditioning all samples under TAPPI conditions (23±1° C. and 50±2 percent relative humidity) for a minimum of 4 hours. Basis weight of sample is measured by selecting 9 products (also referred to as sheets) of the finished sample. In the event the sample consists of perforated sheets of bath or towel tissue, the perforations must be aligned on the same side when stacking the usable units. A precision cutter is used to cut the stack into exactly 10.16 cm×10.16 cm (4.0 inch×4.0 inch) squares. The stack of cut squares make a basis weight pad of 9 squares thick. Alternatively, the basis weight pad consists of two stacks, each stack having 8 sheets of 7.62 cm×. 7.62 cm (3.0 inch×3.0 inch) squares. The basis weight pad is then weighed on a top loading balance with a minimum resolution of 0.01 grams. The top loading balance must be protected from air drafts and other disturbances using a draft shield. Weights are recorded when the readings on the top loading balance become constant. The mass of the sample (grams) per unit area (square meters) is calculated and reported as the basis weight, having units of grams per square meter (gsm). Caliper is measured in accordance with TAPPI test methods Test Method T 580 pm-12 “Thickness (caliper) of towel, tissue, napkin and facial products.” The micrometer used for carrying out caliper measurements is an Emveco 200-A Tissue Caliper Tester (Emveco, Inc., Newberg, OR). The micrometer has a load of 2 kilopascals, a pressure foot area of 2,500 square millimeters, a pressure foot diameter of 56.42 millimeters, a dwell time of 3 seconds and a lowering rate of 0.8 millimeters per second.

Tensile testing is conducted on a tensile testing machine maintaining a constant rate of elongation and the width of each specimen tested is 3 inches. Testing is conducted under TAPPI conditions. Prior to testing samples are conditioned under TAPPI conditions (23±1° C. and 50±2 percent relative humidity) for at least 4 hours and then cutting a 3±0.05 inches (76.2±1.3 mm) wide strip in either the machine direction (MD) or cross-machine direction (CD) orientation using a JDC Precision Sample Cutter (Thwing-Albert Instrument Company, Philadelphia, PA, Model No. JDC 3-10, Serial No. 37333) or equivalent. The instrument used for measuring tensile strengths was an MTS Systems Sintech 11S, Serial No. 6233. The data acquisition software was MTS TestWorks® for Windows Ver. 3.10 (MTS Systems Corp., Research Triangle Park, NC). The load cell was selected from either a 50 Newton or 100 Newton maximum, depending on the strength of the sample being tested, such that the majority of peak load values fall between 10 to 90 percent of the load cell's full-scale value. The gauge length between jaws was 4±0.04 inches (101.6±1 mm) for facial tissue and towels and 2±0.02 inches (50.8±0.5 mm) for bath tissue. The crosshead speed was 10±0.4 inches/min (254±1 mm/min), and the break sensitivity was set at 65 percent. The sample was placed in the jaws of the instrument, centered both vertically and horizontally. The test was then started and ended when the specimen broke. The peak load was recorded as either the “MD tensile strength” or the “CD tensile strength” of the specimen depending on direction of the sample being tested. Ten representative specimens were tested for each product or sheet and the arithmetic average of all individual specimen tests was recorded as the appropriate MD or CD tensile strength having units of grams per three inches (g/3″). Tensile energy absorbed (TEA) and slope are also calculated by the tensile tester. TEA is reported in units of g·cm/cm² and slope is recorded in units of kilograms (kg). Both TEA and Slope are directionally dependent and thus MD and CD directions are measured independently.

The Slough test provides a quantitative measure of the abrasion resistance of a tissue sample. More specifically, the test measures the resistance of a material to an abrasive action when the material is subjected to a horizontally reciprocating surface abrader. The equipment used to measure Slough is similar to that described in U.S. Pat. No. 6,808,595. The abrading spindle consists of a stainless-steel rod, approximately 1.25 cm (0.495 inches) in diameter and 15.25 cm (6 inches) in length. The abrasive portion of the abrading spindle is 10.8 cm (4.25 inches) in length and consists of 18/22 abrasion coating (commercially available from Superabrasives, Inc., Wixom, MI) applied around the entire circumference of the abrading spindle. The abrading spindle is mounted perpendicularly to the face of the instrument such that the abrasive portion of the abrading spindle extends out its entire distance from the face of the instrument. On each side of the abrading spindle is located a pair of clamps, one movable and one fixed. The clamps are spaced 10 cm (4 inches) apart and centered about the abrading spindle. The movable clamp (weighing approximately 21 grams) is allowed to slide freely in the vertical direction, the weight of the movable clamp providing the means for ensuring a constant tension of the tissue sheet sample over the surface of the abrading spindle. Instruments for measuring Slough according to the present disclosure are available at Accelerated Analytical Laboratories (Milwaukee, WI).

Prior to testing, any loose dust should be removed from the abrading spindle with compressed air. If other debris is present on the abrading spindle, the spindle may be washed in warm water and dish detergent, rinsed with distilled water and dried in an oven. In the event the abrading spindle is washed prior to use, care must be taken to ensure that all cleaning solution is rinsed from the abrading spindle and that it is completely dry before use.

Samples are conditioned under TAPPI conditions (23±1° C. and 50±2 percent relative humidity) for a minimum of 4 hours prior to testing. For perforated bath tissue products, samples are first prepared by unrolling the tissue and separating into lengths of 3 sheets. Using a precision cutter, such as a JDC-3 cutter (commercially available from Thwing-Albert Instrument Company, Philadelphia, PA), each sample is cut to a size of 177.8±13 mm (7.0±0.5 inches) in the machine direction (MD) by 76.2±1 mm (3.0±0.04 inches) in the cross-machine direction (CD). When cutting perforated bath tissue products, the sample 100 is cut such that the sample 100 has a first end 102 having a length of 25.4 mm (1 inch) and a second end 104 having a length of 50.8 mm (2 inches) which ensures that the spindle does not abrade over the perforations 105, 107 in the sample 100.

When testing rolled and perforated bath tissue products testing should be done on the outside surface of the roll as it is unwound. Generally, rolled and perforated bath tissue products are not separated into individual plies prior to testing and the outer surface of the product, as it is unwound from the roll, is tested. When testing folded facial tissue products, the product is separated into individual plies and the outward facing side of one of the outer plies is tested.

Each tissue sheet sample is weighed to the nearest 0.1 mg. One end of the tissue sheet sample is clamped to the fixed clamp, the sample is then loosely draped over the abrading spindle and clamped into the sliding clamp. The entire width of the sample should be in contact with the abrading spindle. The sliding clamp is then allowed to fall providing constant tension across the abrading spindle. The entire width of the tissue sheet sample should be in contact with the abrading spindle.

Once the sample is secured the test begins by moving the abrading spindle back and forth at an approximate 15-degree angle from the centered vertical centerline in a reciprocal horizontal motion against the tissue sample for 40 cycles at a speed of 73.5±0.5 cycles per minute. As the spindle cycles, it is also rotated counterclockwise (when looking at the front of the instrument) at an approximate speed of 5 RPMs. Once the 40 cycles are complete, the tissue sample is removed from the jaws with the fingertips and both sides of the sample are blown with air having a flow rate of approximately 3.4 scfm for approximately 13 seconds to remove debris.

The tissue sheet sample is then weighed to the nearest 0.1 mg and the weight loss calculated. The difference between the initial weight and the weight after testing is the amount of Slough. Ten samples are tested and the average weight loss value in milligrams (mg) is recorded, which is the Slough value for the sample.

Softness was measured using an EMTEC Tissue Softness Analyzer (“TSA”) (Emtec Electronic GmbH, Leipzig, Germany), calibrated according to the manufacturer's instructions. The TSA comprises a rotor with vertical blades which rotate on the tissue sample applying a defined contact pressure. The blades are pressed against the sample with a load of 100 mN and the rotational speed of the blades is two revolutions per second. Contact between the vertical blades and the tissue sample creates vibrations, which are sensed by a vibration sensor. The sensor then transmits a signal to a PC for processing and display. The signal is displayed as a frequency spectrum. The frequency analysis in the range of approximately 200 to 1000 Hz represents the surface smoothness or texture of the sample. A high amplitude peak occurring between 200 to 1000 Hz correlates to a rougher surface and is reported as the TS750 value, having units of dB V2 rms. A further peak in the frequency range between 6 and 7 kHZ represents the softness of the sample. The peak in the frequency range between 6 and 7 kHZ is herein referred to as the TS7 value and is expressed as dB V2 rms. A high amplitude peak correlates to less soft surface, while a low amplitude peak correlates a softer surface.

Tissue product samples were prepared by cutting a circular sample having a diameter of 112.8 mm. All samples were allowed to equilibrate at TAPPI conditions for at least 24 hours prior to completing the TSA testing. After conditioning each sample was tested as-is, i.e., multi-ply products were tested without separating the sample into individual plies.

Samples are mounted into the instrument and the test is carried out according to the manufacturer's instructions. When complete, the TSA software displays values for TS7 and TS750. These values are recorded to the nearest 0.01 dB V2 rms. Once testing is complete, the sample is removed from the instrument and discarded. The test is performed on the top surface (outer facing surface of a rolled product) of five of the replicate samples, using a new sample for each test. The five test results are averaged and the average value is reported.

### CONCLUSION

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As used in the specification and the appended claims, the singular forms “a”, “an”, and “the” include plural referents unless the context clearly dictates otherwise.

Ranges may be expressed herein as from one particular value to another particular value. When such a range is expressed, another aspect includes from the one particular value to the other particular value. It will be further understood that the endpoints of each of the ranges are significant both in relation to the other endpoint and independently of the other endpoint. Similarly, the values listed include approximations of these values. In one non-limiting aspect the terms are defined to be within 10%. In another non-limiting aspect, the terms are defined to be within 5%. In still another non-limiting aspect, the terms are defined to be within 1%.

The terms “coupled”, “connected”, and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

Certain terminology is used in the following description for convenience only and is not limiting. The words “lower” and “upper” designate direction in the drawings to which reference is made. The words “inner” and “outer” refer to directions toward and away from, respectively, the geometric center of the described feature or device. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description is presented for purposes of illustration and is not intended to be exhaustive or limiting. Many modifications and variations will be apparent to those of ordinary skill in the art without departing from the scope and spirit of the disclosure.

### Exemplary Implementations

Example 1. A multi-ply tissue product comprising: two or more wet pressed and creped tissue plies, the multi-ply tissue product defining a first outer surface and a second outer surface opposite the first outer surface, at least the first outer surface defining a three-dimensional surface topography including a plurality of ridges separated by valleys, wherein: each of the plurality of ridges defines a height of 50 μm to 355 μm, each of the plurality of ridges is spaced apart from an adjacent ridge by a distance of 500 m to 2,000 μm, the multi-ply tissue product has a stiffness index of 7.4 to 9.4, and the multi-ply tissue product has a TS7 value of less than 15.
Example 2. The multi-ply tissue product of example 1, wherein the three-dimensional surface topography is produced by a textured creping blade.
Example 3. The multi-ply tissue product of example 1, wherein the plurality of ridges includes 50 ridges per inch to 12 ridges per inch.
Example 4. The multi-ply tissue product of example 1, wherein the plurality of ridges define an indentation spacing of 500 μm to 2,000 μm.
Example 5. The multi-ply tissue product of example 1, wherein the two or more wet pressed and creped tissue plies comprise a conventional creping composition.
Example 6. The multi-ply tissue product of example 5, wherein the multi-ply tissue product is produced with under 3 milligrams of slough.
Example 7. The multi-ply tissue product of example 1, wherein the second outer surface of the tissue product defines a three-dimensional surface topography including a plurality of ridges separated by valleys.
Example 8. The multi-ply tissue product of example 7, wherein the multi-ply tissue product defines a caliper of 375 μm to 630 μm.
Example 9. The multi-ply tissue product of example 7, wherein the multi-ply tissue product defines a basis weight of 40 gsm to 42 gsm.
Example 10. The multi-ply tissue product of example 7, wherein the multi-ply tissue product defines a geometric mean tensile of 1,200 g/3″ to 1,560 g/3″.
Example 11. The multi-ply tissue product of example 7, wherein the multi-ply tissue product has a TS750 value of 40 to 112.
Example 12. The multi-ply tissue product of example 7, wherein the multi-ply tissue product has a TS750 value of 40 to 65.
Example 13. The multi-ply tissue product of example 7, wherein the multi-ply tissue product has a TS7 value of less than 12.
Example 14. The multi-ply tissue product of example 1, wherein the multi-ply tissue product has a converted product caliper of 400 microns to 575 microns
Example 15. The multi-ply tissue product of example 1, wherein the two or more wet pressed and creped tissue plies comprise a conventional creping composition.
Example 16. The multi-ply tissue product of example 15, wherein the multi-ply tissue product is produced with under 3 milligrams of slough.
Example 17. A multi-ply tissue product comprising: two or more wet pressed and creped tissue plies, the multi-ply tissue product defining a first outer surface and a second outer surface opposite the first outer surface, at least the first outer surface defining a plurality of ridges formed by a textured creping blade and separated by valleys, wherein: the plurality of ridges includes 50 ridges per inch to 12 ridges per inch, each of the plurality of ridges is spaced apart from an adjacent ridge by a distance of 500 μm to 2,000 μm, the multi-ply tissue product has a geometric mean tensile of 1,100 g/3″ to 1,600 g/3″, the multi-ply tissue product has a stiffness index of 7.4 to 9.4, the multi-ply tissue product has a TS750 value greater than 45, and the multi-ply tissue product has a TS7 value of less than 13.
Example 18. The multi-ply tissue product of example 16, wherein the second outer surface defines a three-dimensional surface topography including a plurality of ridges separated by valleys.
Example 19. The multi-ply tissue product of example 17, wherein the multi-ply tissue product defines a caliper of 375 μm to 630 μm.
Example 20. The multi-ply tissue product of example 18, wherein the two or more tissue plies comprise a conventional creping composition, and wherein the three-dimensional surface topography is produced by a textured creping blade.
Example 21. The multi-ply tissue product of example 18, wherein the two or more tissue plies comprise a conventional creping composition, and wherein the three-dimensional surface topography is produced by a textured creping blade.
Example 22. A method comprising: applying a creping composition to a Yankee dryer drum; applying a first tissue ply to the Yankee dryer drum; creping the first tissue ply from the Yankee dryer drum with a textured creping blade; applying a second tissue ply to the Yankee dryer drum; creping the second tissue ply from the Yankee dryer drum with the textured creping blade; and marrying the first tissue ply and the second tissue ply to create a multi-ply tissue product having a stiffness index of 7.4 to 9.4, a TS750 value of 40 to 112, and a TS7 value of less than 15.
Example 23. The method of example 22, wherein marrying the first tissue ply and the second tissue ply creates the multi-ply tissue product having a caliper of 375 μm to 630 μm.
Example 24. The method of example 22, wherein the creping composition is a conventional creping composition.
Example 25. The method of example 22, wherein the creping composition is a conventional creping composition comprising at least one water soluble polymer, wherein the water soluble polymer is selected from the group consisting of polyamidoamine-epichlorohydrin resin, polyamine-epichlorohydrin resin, polyvinyl alcohol, polyvinylamine, polyethyleneimine, polyacrylamide, polymethacrylamide, poly(acrylic acid), poly(methacrylic acid), poly(hydroxyethyl acrylate), poly(hydroxyethyl methacrylate), poly(n-vinyl pyrrolidinone), poly(ethylene oxide), hydroxyethyl cellulose, hydroxypropyl cellulose, guar gum, starch, agar, chitosan, alginic acid, carboxymethyl cellulose, highly branched polyamidoamines

1. A multi-ply tissue product comprising:
two or more wet pressed and creped tissue plies, the multi-ply tissue product defining a first outer surface and a second outer surface opposite the first outer surface, at least the first outer surface defining a three-dimensional surface topography including a plurality of ridges separated by valleys,
wherein:
each of the plurality of ridges defines a height of 50 μm to 355 μm,
each of the plurality of ridges is spaced apart from an adjacent ridge by a distance of 500 μm to 2,000 μm,
the multi-ply tissue product has a stiffness index of 7.4 to 9.4, and
the multi-ply tissue product has a TS7 value of less than 15.

2. The multi-ply tissue product of claim 1, wherein the three-dimensional surface topography is produced by a textured creping blade.

3. The multi-ply tissue product of claim 1, wherein the plurality of ridges includes 50 ridges per inch to 12 ridges per inch.

4. The multi-ply tissue product of claim 1, wherein the plurality of ridges define an indentation spacing of 500 μm to 2,000 μm.

5. The multi-ply tissue product of claim 1, wherein the two or more wet pressed and creped tissue plies comprise a conventional creping composition.

6. The multi-ply tissue product of claim 5, wherein the multi-ply tissue product is produced with under 3 milligrams of slough.

7. The multi-ply tissue product of claim 1, wherein the second outer surface of the tissue product defines a three-dimensional surface topography including a plurality of ridges separated by valleys.

8. The multi-ply tissue product of claim 7, wherein the multi-ply tissue product defines a caliper of 375 μm to 630 μm.

9. The multi-ply tissue product of claim 7, wherein the multi-ply tissue product defines a basis weight of 40 gsm to 42 gsm.

10. The multi-ply tissue product of claim 7, wherein the multi-ply tissue product defines a geometric mean tensile of 1,200 g/3″ to 1,560 g/3″.

11. The multi-ply tissue product of claim 7, wherein the multi-ply tissue product has a TS750 value of 40 to 112.

12. The multi-ply tissue product of claim 7, wherein the multi-ply tissue product has a TS750 value of 40 to 65.

13. The multi-ply tissue product of claim 7, wherein the multi-ply tissue product has a TS7 value of less than 12.

14. The multi-ply tissue product of claim 1, wherein the multi-ply tissue product has a converted product caliper of 400 microns to 575 microns.

15. The multi-ply tissue product of claim 1, wherein the two or more wet pressed and creped tissue plies comprise a conventional creping composition.

16. The multi-ply tissue product of claim 15, wherein the multi-ply tissue product is produced with under 3 milligrams of slough.

17. A multi-ply tissue product comprising:
two or more wet pressed and creped tissue plies, the multi-ply tissue product defining a first outer surface and a second outer surface opposite the first outer surface, at least the first outer surface defining a plurality of ridges formed by a textured creping blade and separated by valleys,
wherein:
the plurality of ridges includes 50 ridges per inch to 12 ridges per inch,
each of the plurality of ridges is spaced apart from an adjacent ridge by a distance of 500 μm to 2,000 μm,
the multi-ply tissue product has a geometric mean tensile of 1,100 g/3″ to 1,600 g/3″,
the multi-ply tissue product has a stiffness index of 7.4 to 9.4,
the multi-ply tissue product has a TS750 value greater than 45, and
the multi-ply tissue product has a TS7 value of less than 13.

18. The multi-ply tissue product of claim 17, wherein the second outer surface defines a three-dimensional surface topography including a plurality of ridges separated by valleys.

19. The multi-ply tissue product of claim 17, wherein the multi-ply tissue product defines a caliper of 375 μm to 630 μm.

20. The multi-ply tissue product of claim 18, wherein the two or more tissue plies comprise a conventional creping composition, and
wherein the three-dimensional surface topography is produced by a textured creping blade.

21. The multi-ply tissue product of claim 18, wherein the two or more tissue plies comprise a conventional creping composition, and
wherein the three-dimensional surface topography is produced by a textured creping blade.

22. A method comprising:
applying a creping composition to a Yankee dryer drum;
applying a first tissue ply to the Yankee dryer drum;
creping the first tissue ply from the Yankee dryer drum with a textured creping blade;
applying a second tissue ply to the Yankee dryer drum;
creping the second tissue ply from the Yankee dryer drum with the textured creping blade; and
marrying the first tissue ply and the second tissue ply to create a multi-ply tissue product having a stiffness index of 7.4 to 9.4, a TS750 value of 40 to 112, and a TS7 value of less than 15.

23. The method of claim 22, wherein marrying the first tissue ply and the second tissue ply creates the multi-ply tissue product having a caliper of 375 μm to 630 μm.

24. The method of claim 22, wherein the creping composition is a conventional creping composition.

25. The method of claim 22, wherein the creping composition is a conventional creping composition comprising at least one water soluble polymer, wherein the water soluble polymer is selected from the group consisting of polyamidoamine-epichlorohydrin resin, polyamine-epichlorohydrin resin, polyvinyl alcohol, polyvinylamine, polyethyleneimine, polyacrylamide, polymethacrylamide, poly(acrylic acid), poly(methacylic acid), poly(hydroxyethyl acrylate), poly(hydroxyethyl methacrylate), poly(n-vinyl pyrrolidinone), poly(ethylene oxide), hydroxyethyl cellulose, hydroxypropyl cellulose, guar gum, starch, agar, chitosan, alginic acid, carboxymethyl cellulose, highly branched polyamidoamines.
